(19) United States
(12) Patent Application Publication
(10) Pub. No.: US 2018/0350351 A1
(43) Pub. Date: Dec. 6, 2018

(54) FEATURE EXTRACTION USING NEURAL NETWORK ACCELERATOR

(71) Applicant: Intel Corporation, Santa Clara, CA (US)

(72) Inventors: Michal Kopys, Lebcz (PL); Piotr Rozen, Gdansk (PL)

(73) Assignee: Intel Corporation, Santa Clara, CA (US)

(21) Appl. No.: 15/609,300

(22) Filed: May 31, 2017

(51) Int. Cl. G10L 15/16; G06N 3/04; G06N 3/08; G10L 15/02; G10L 25/24

(52) U.S. Cl. CPC G10L 15/16; G06N 3/04; G10L 25/24; G10L 15/02; G06N 3/08

(57) ABSTRACT

Feature extraction is described for speech recognition using a neural network accelerator. In one example an audio clip is received for feature extraction. A plurality of feature extraction operations are performed on the audio clip using matrix-matrix multiplication of a hardware neural network accelerator, and features are produced for speech recognition.

### FIELD

The present description relates to the field of speech recognition and, in particular, to implementing speech recognition using hardware acceleration.

### BACKGROUND

The world of electronic device user interfaces (UI) is evolving. Yesterday computer interaction used a keyboard, mouse, and display. Then the smartphone revolution came and caused a switch toward touch interfaces. Today, when more and more people are using audio digital assistants in smartphones and desktops, the importance of speech to text applications for a speech UI is growing. Apart from smartphones, the speech UI gains still more momentum in small wearable and home automation devices which, in most cases, do not have a display at all.

The automated speech recognition (ASR) system, which is the main part of a speech UI, is highly demanding in the context of MIPS (Millions of Instructions per Second) and memory. As a result, many devices deploy speech recognition as a remote service. A typical smartphone or smart hub records user speech, sends the speech to a server, and then receives the recognized speech or a command based on the speech from the server. This allows the complex speech recognition tasks to be performed on large, powerful servers that may be updated and improved without affecting the user or the user hardware.

For a web request, e.g. “what is the weather forecast?” there is no added delay. The request must be answered by a remote service so the time to communicate with a remote server does not add significantly to the delay. For a local command, e.g. “turn on the lights,” the delay in sending the audio to a server and receiving the recognized speech or a light control command may be noticeable. For some devices, the nature of the device may require a faster response. As a result, there are efforts to implement ASR locally in the device.

Most common ASR implementations are purely software. However software ASR requirements are hard to meet on small portable devices, such as wearables, where battery size processing capability is small. To resolve the problem of small battery capacity and small processors, different types of low power hardware (HW) accelerators have been added to device designs. This allows demanding workloads like feature extraction or acoustic scoring to be offloaded to dedicated low power hardware.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an overview of a speech recognition system according to an embodiment.

FIG. 2 is a diagram of a neural network accelerator according to an embodiment.

FIG. 3 is a hardware module diagram for performing an MFCC on a neural network accelerator according to an embodiment.

FIG. 4 is a diagram of interleaving on a neural network accelerator according to an embodiment.

FIG. 5 is a diagram of components for performing pre-processing according to an embodiment.

FIG. 6 is a diagram of a DNN on a neural network accelerator according to an embodiment.

FIG. 7 is a diagram of a diagonal on a neural network accelerator according to an embodiment.

FIG. 8 is a diagram of de-interleaving on a neural network accelerator according to an embodiment.

FIG. 9 is a diagram of RNN on a neural network accelerator according to an embodiment.

FIG. 10 is a diagram of components for performing merge features according to an embodiment.

FIG. 11 is a block diagram of a computing device incorporating a speech recognition system using a neural network accelerator according to an embodiment.

### DETAILED DESCRIPTION

Hardware accelerators have been developed for a variety of different tasks in computing systems. Some systems have hardware accelerators for graphics rendering, for neural networks, for image processing, for speech recognition and for other tasks. Each accelerator requires some circuitry and may also require some standby power even when it is not being used. In this description, acoustic feature extraction, for example Mel Filter Cepstrum Coefficients (MFCC), is performed in a neural network accelerator without any modifications being required to the neural network accelerator hardware. Using existing hardware to also perform ASR functions allows for faster ASR performance with less cost and lower power.

By reusing a neural network HW accelerator for both neural network processing and feature extraction both die area and power are saved over designing and producing two different types of accelerators. HW accelerators have been developed specifically for feature extraction with Mel Filter Cepstrum Coefficients (MFCC) techniques, but these accelerators are not suitable for other functions.

MFCC is a common transformation used in Automated Speech Recognition (ASR) systems. MFCC seeks to derive coefficients from a cepstral representation of an audio clip. The clip is windowed, transformed to the frequency domain, and mapped onto the Mel scale to resemble auditory perception. The mapped powers are logged and a discrete cosine transform (DCT) is used to generate amplitudes representing a coefficient for each window of the spectrum. After some additional normalizing or simplifying, the coefficients of MFCC are then used as features that can uniquely identify words, phonemes, etc. The windows, the Mel spectrum bands, and the particular operations may be modified for different applications. Other types of audio feature extraction systems with different names represent variations from what is described here and may also benefit from the techniques described below. A variety of different filtering and normalizing operations may also be added to the transformation at different stages.

MFCC is also used with some speech compression and communication functions. Feature extraction is a transformation which creates a small set of normalized features for short period signals. The number of features is much smaller and more descriptive compared to the pure audio signal before feature extraction. In speech recognition, a common frame size is around 25 ms. For a sampling rate of 16 KHz, 25 ms provides 400 samples. MFCC techniques can generate from 13 to 39 features for the 25 ms frame. Such a large number of samples requires significant processing and memory resources. The features are buffered in memory and then are used as an input to an acoustic scoring module.

Neural networks and artificial intelligence are being seen as an answer to almost any difficult computing problem. It is possible to train a neural network to approximate the results of a determinative MFCC transform. When the training is based on inputs and outputs from an MFCC transform, the resulting network does not give satisfactory results. Even when the results are similar to that of a traditional MFCC implementation, the accuracy of the neural network is significantly lower. While neural networks often perform well for poorly defined associative tasks, MFCC is not such a task. As described herein, high accuracy is achieved for ASR using only hardware that is targeted for neural network acceleration. To do this the MFCC approach is changed and the neural network accelerator is uniquely configured. At the same time, the acoustic model does not require any change.

As described herein instead of training the network to give the same results as a target feature extraction transform, a processor of the system reconfigures the hardware to perform some of the MFCC operations using basic techniques from the neural network accelerator. As described herein matrix-matrix multiplication is applied to many MFCC tasks and non-linear function transforms are modeled as piece wise linear functions. This approach provides a precision that matches a classic implementation but uses neural network accelerated primitives. This approach can be used as a direct replacement for a separate feature extraction module.

By reusing the neural network hardware to accelerate two stages of speech recognition systems, in particular feature extraction and acoustic scoring, a speech recognition or voice command device may be produced at lower cost. While the benefits are greatest for small low power devices, such as wearables and Internet of Things (IoT) devices, any device can benefit from lower cost and simpler hardware. Software speech recognition on wearable devices can take most of the CPU compute resources. Using hardware acceleration with the techniques described herein reduces CPU usage by a factor of ten or more without having a special feature extraction hardware accelerator. Other portable devices may benefit by reducing power consumption and thereby extending battery life.

As described herein an MFCC methodology is converted to matrix multiplications, PWL approximations, such as activation functions, and biases. These operations may all be done as part of the layer computations for a DNN (Deep Neural Network) or other type of neural network hardware. The training and other functionality of a neural network accelerator is not necessarily required.

As described, this may be implemented as 28 small layers. Each activation function and the values of weights may be set manually to realize each part of the feature extraction functionality. Furthermore, some connections between layers are set, e.g. the outputs from two layers are one input for the next layer and the output from one layer is saved to buffer (input for the previous layer) for the next request.

In addition, feature extraction uses larger values than is common for many neural network accelerator tasks. This can cause saturation. As a result, the feature extraction values may be scaled values or a logarithmic addition may be used, for example the natural logarithm of the sum. Such scaling may be implemented using the DNN or PWL mentioned herein.

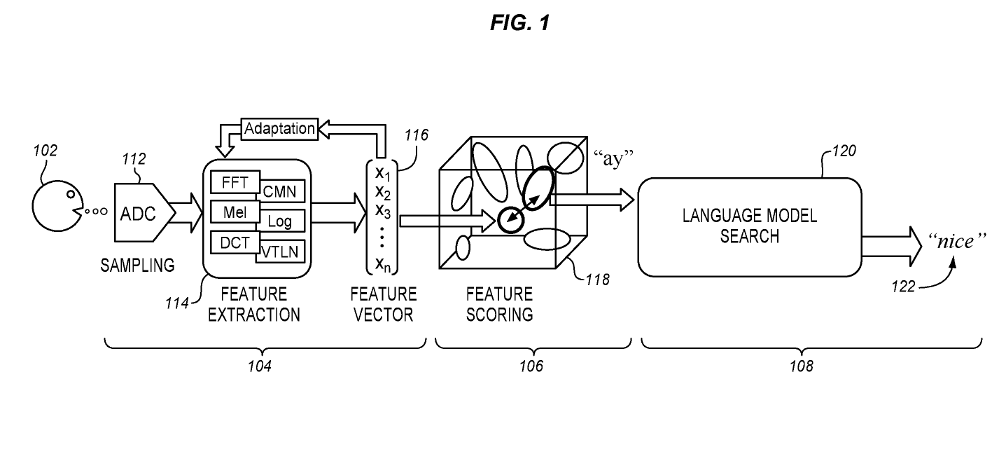

FIG. 1 is an overview of speech recognition as it may be performed on a wearable, portable, or fixed device or in cooperation with a server. A speaker 102, which may be local to the device or remote, provides a speech utterance. The utterance is received in an acoustic frontend 104 which produces a feature vector. The feature vector contains aspects of distinctive audio features in the utterance. The particular nature of these features will vary for different speech recognition systems. The feature vector is provided to an acoustic scoring model 106 that is used to determine which features are significant and how significant. The scores are then provided to a backend search module 108. The backend search then provides an output 122 such as text, phonemes, or some other representation of words as determined by the speech recognition system.

The acoustic frontend 104 receives the raw audio as uttered by the speaker 102. This is converted into some digital form at an analog to digital converter (ADC) for processing in later stages. In some embodiments, the ADC is in the form of a local microphone. In other embodiments, the speech is received from a separate device in a digital form and may be transcoded downsampled or otherwise modified for use by the later stages. The digital audio of the spoken utterance is provided to a feature extraction module 114 of the acoustic frontend 104. The feature extraction module produces a feature vector 116. In some embodiments, the feature vector is fed back to the feature extraction module for adaptation to different speakers and environments.

The feature extraction may be performed in any of a variety of different ways. In the described examples MFCC is used but the embodiments are not so limited. The feature extraction accordingly may include multiple sequential deterministic stages as described in more detail below. These may include a fast Fourier transform (FFT), applying Mel filters (Mel), a discrete cosine transform (DCT), a Cepstral Mean Normalization (CMN), applying log filters (log), and a Vocal Tract Length Normalization (VTLN), among others. The particular operations, the ordering, and how the operations are applied may be adapted to suit different implementations and some of these are described in more detail below.

The feature vector, which may be adapted to an environment or speaker, is applied to acoustic model scoring 106. This may involve feature scoring 118 or any of a variety of other processes to analyze the features of the received feature vectors. The scored features are then applied to a backend search 108 to produce recognized speech 122 as a result. The backend search will typically take the scored features from acoustic units as received from the acoustic scoring and convert these into words and then take the words and apply meaning to them through language and parsing. The search may be done using Hidden Markov Models (HMM), Viterbi searches or other techniques. A language model search 120 may access acoustic models, phoneme to word maps, glossaries and language and grammar rules and conventions, etc.

The result output 122 is typically provided as a text sequence indicating what the user spoke. In some systems only the words that are necessary to responding to the speech utterance are provided. This is then applied to a command interface as a request or command. The device then executes the command, replies to the query or operates in any other suitable way depending on the particular implementation.

A variety of different neural networks are being used in artificial intelligence systems and, in some cases, neural network accelerators are provided in dedicated hardware to speed the execution of tasks on neural networks as compared to software systems. One such neural network is a convolutional neural network (CNN) which is frequently being used in the field of computer-vision to reason about natural images. Functions output high-level information about an image such as image-classification and object localization. A common CNN is composed from simple functional operators on images, frequently referred to as layers, that are chained together, i.e. applied one after another, to build a complex function, referred to as a network.

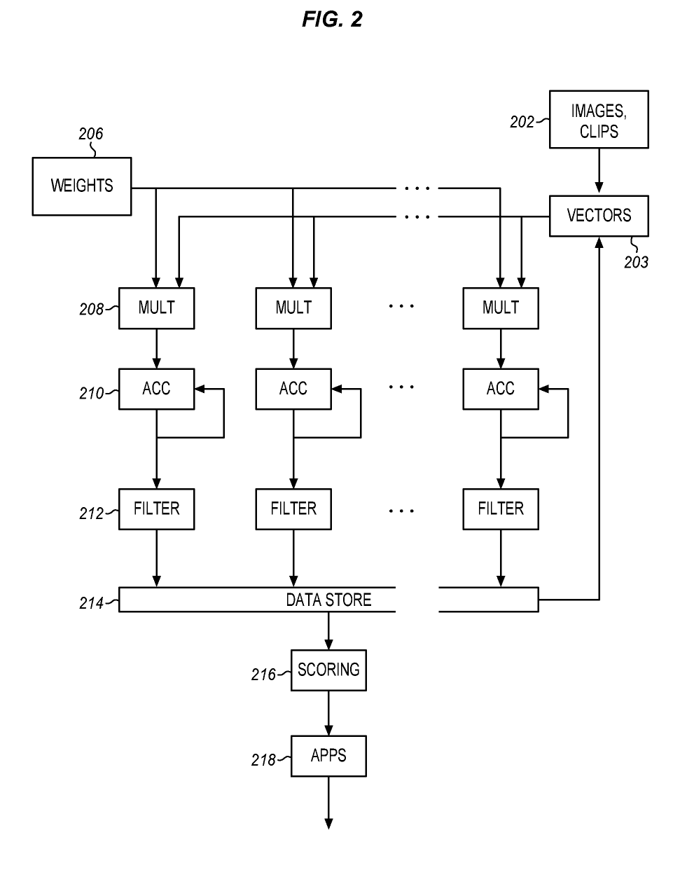

FIG. 2 is a diagram of an example of such layers to show the operation of a neural network accelerator. The process starts with an image 202 or image data. The image may be captured by a camera system as still or video imagery. Other types of data may also be applied to the neural network including audio. Alternatively, the image or images may be taken from storage or received from a remote source. The image may optionally be pre-processed to a common size, common response range, common scale, or for any other type of norming or standardizing. Vectors 203 are derived from the image data and then the vectors are applied to a chain of multipliers 208. While three multipliers are shown, there may be many more. At the same time weights 206 are also applied to the chain of multipliers. At each cycle of the multipliers one of the columns of the weights and the vector are multiplied and the result is then applied to a chain of accumulators. The chain of multipliers may be very wide.

The accumulations are then applied each to a chain of non-linear filters 212. The results are stored in a memory 214 and then developed to produce more vectors 203 or may be scored. The arithmetic units may be configured by a connected processor using the memory connections and weights to perform adds, shifts, conditional moves, and other functions to achieve parallel matrix multiplications. Additional units (not shown) may be provided to perform other logical functions. The accelerator is coupled to a processor or controller, such as a central processing unit to receive vectors, weights, configuration parameters and other control and input data.

The scoring results or other metadata are then provided to other applications 218, such as machine vision, image understanding or other functions. These may include any of a variety of different functions, depending on the implementation, such as object identification, object tracking, inspection, classification and other functions. The machine vision interprets the metadata in a way consistent with the intended function. The interpretations are provided as results to an execution engine to act based on the vision results. The action may range from setting a flag to articulating a robot. The components of the drawing figure may all form part of a single machine or computing system or the parts may be distributed into disparate separate components. For speech recognition functions, the results will be provided to the speech recognition application as described in more detail below.

The neural network hardware provides a variety of mathematical functions that are used as described herein to implement speech recognition functions. Feature extraction may accordingly be implemented on the same hardware as is used for a neural network. No special functionality or modification of the basic hardware is required to provide these functions. The same primitives, matrix multiplication, linear filtering, etc. that are used for image understanding or other neural network functions are used to perform a MFCC. No additional silicon circuitry is required on the die and the hardware speech recognition is fast and low power. Since speech recognition is used only infrequently in most applications, the overall impact on the system will be low. The neural network will still be available to perform its other assigned functions.

The present description is presented in the context of an MFCC feature extraction, however, the same approach may be applied to other components of a speech recognition system and to other feature extraction techniques. In these examples, the MFCC is performed using neural network primitives.

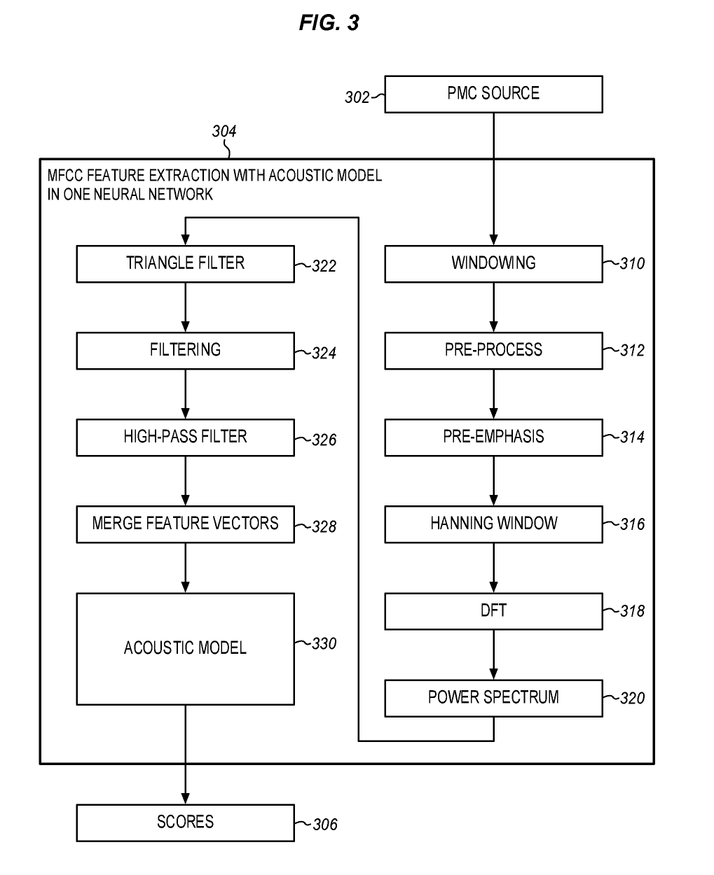

FIG. 3 is a hardware module diagram for performing an MFCC on a neural network accelerator. The accelerator hardware 304 receives an appropriate audio source, such as a PMC (Parallel Model Combination) source 302. After processing through the MFCC, scores are generated as an output 306. Within the neural network hardware 304, MFCC may be performed in any of a variety of different ways. In the example of the diagram, the MFCC technique is separated out into several discrete sub-operations, each formed in a part of the hardware accelerator. The sub-operations may include windowing, pre-processing, pre-emphasis, Hanning window, DFT, power spectrum or logarithm spectrum, triangle filter, liftering, high-pass filtering, merging feature vectors. These functions are used to build an acoustic model. The output scores come from the acoustic model.

Not all operations are necessarily required, additional operations may be added, and some of the described operations may be modified to suit different applications. For other audio feature extraction techniques many of the same operations are performed with modification in order and execution. These other techniques may also benefit from the approaches described herein.

Within the accelerator, the output from one sub-operation is used as the input for the next one. Each sub-operation may be performed using only matrix-matrix multiplication and piece wise linear functions based on a lookup table. Each of the sub-operations is modified from its conventional definition to be performed using the matrix-matrix multiplications and lookup tables.

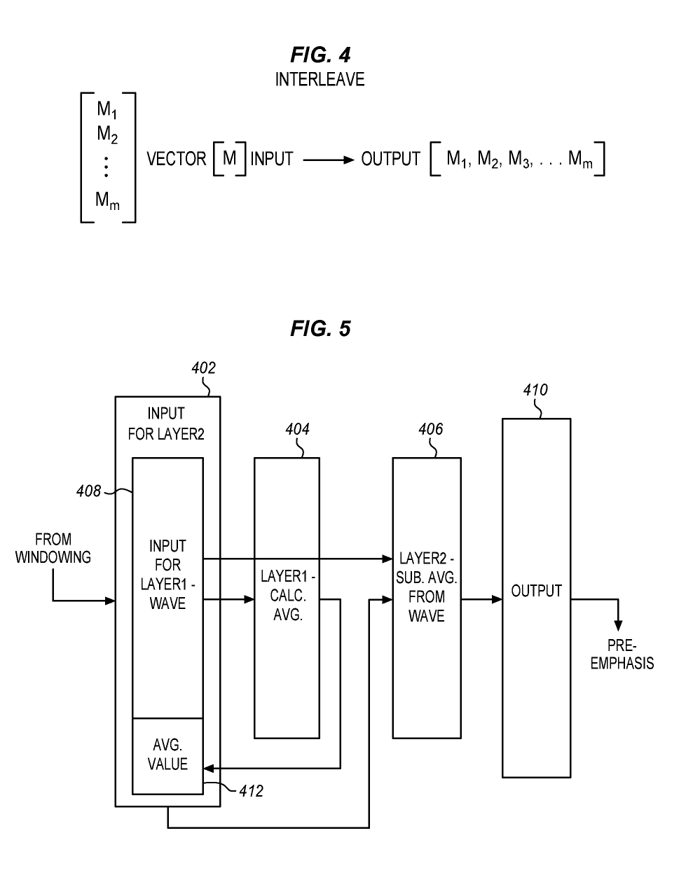

Windowing may be performed using matrix-matrix multiplication with values equal to one or zero to split the stream into frames. The input data is first copied in one matrix operation and then interleaved, as determined by the settings for the matrix values. FIG. 4 is an example of interleaving using matrix-matrix multiplication. The input is a vertical column matrix of values M₁, M₂, M₃ . . . Mₘ which is multiplied with another vector to obtain the horizontal row vector with the values in the same order.

Pre-Processing may be performed using two matrix-matrix multiplications. The first matrix calculates average values by summing all of the windowed values from the windowing sub-operation and then using a linear function to divide the total by the number of values e.g. 400. The second matrix subtracts the average value from each input. The subtraction may be represented as output=input−average_value.

FIG. 5 is a diagram of components for performing the described pre-processing tasks. The windowing output is received as an input for layer 2 hardware 402. The input is ordered and applied to layer 1 hardware 404 to determine the average of the values. The average value is stored in a register 412 for application to each of the values at a layer 2 average subtraction 406. This is the output 410 for application to the pre-emphasis sub-operation.

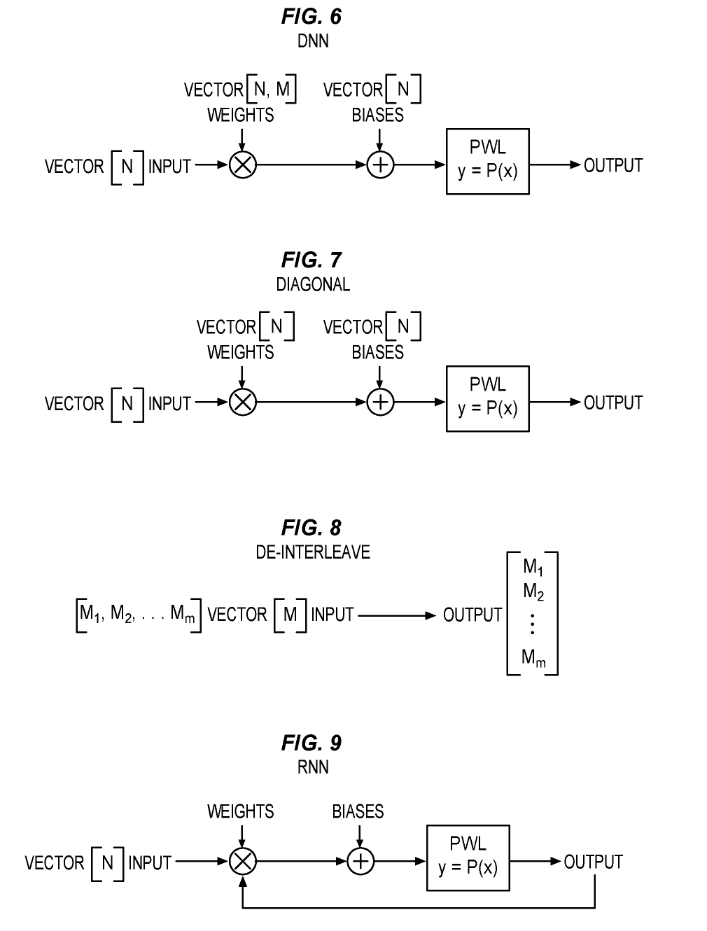

Pre-Emphasis may be performed simply as a single matrix-matrix multiplication to calculate the differences between the inputs. Values of the input matrix are equal to e.g. 1, −1 or 0. FIG. 6 is a diagram of a DNN (Deep Neural Network) matrix function block of an accelerator that may be used to perform the subtractions. As shown in the diagram, an input vector [N] may first be multiplied with a matrix [N,M] of weights. The product is then added to a vector [N] of biases. With the weights and biases set to zero and the result applied to a piece-wise linear function Y=P(X) the differences output is obtained.

Hanning Window may also be performed using simple matrix-matrix multiplications using a matrix that has only one dimension. This operation is used to scale the inputs. FIG. 7 is a diagram of a diagonal matrix multiplication that may be used with the biases all set to zero. The weights may be a Hanning matrix. The input is a vector [N] which applied to a multiplier with the Hanning matrix weights [N]. The result is added to the vector [N] biases which are set to zero. This result is applied to the piece-wise linear function to provide the output.

DFT (Discrete Fourier Transform) may also be performed using a single matrix—matrix multiplication of the DNN type of FIG. 6. In this case, the weights are of two kinds. The first is cos(2πnm/N) for real numbers and the second is sin(2πnm/N) for imaginary numbers. The biases are set to zero. These two kinds of numbers are the result of this operation. The first part of the output is for real numbers and the second part is for imaginary numbers. This is a simplification of a true DFT that is effective for the audio samples being processed as PMC inputs.

Power Spectrum may be performed using two sequential operations, diagonal and DNN. The first is a diagonal functional block, such as that of FIG. 7 with the biases set to zero. This sub-operation determines the following:

output=input.real²+input.imaginary²

An activation function f(x)=x² may be used for the inputs. The real and imaginary numbers are summed, which may also be done using matrix-matrix multiplication). By setting the weights to an appropriate sequence of alternating binary values, 0,1, the output values are equal only to one or zero. For the second DNN operation the weights are set to a binary pattern with the biases at zero to accomplish a function of F(x)=x, instead of the F(x)=x*x/2¹⁵ of the diagonal function. In the second DNN operation the power of the real and imaginary numbers are summed.

The triangle filter uses one matrix-matrix multiplication where each output is for one triangle. The weights are set to a triangle matrix while the biases are set to zero. By controlling the inputs, different logarithmic functions may be performed. Activation functions, such as f(x)=ln(x) are performed through a four sets of matrix-matrix multiplication operations for the triangle filter function.

A DCT (Discrete Cosine Transform) may be implemented with, for example, four DNN layers where the weight values are calculated from cosines function.

Liftering in MFCC is a similar operation to the Hanning window operation. It may be done with a single diagonal matrix-matrix multiplication as in FIG. 7 using one dimension to scale inputs. The weights are from a matrix composed for this purpose.

High-pass filtering may use matrix-matrix multiplication first for de-interlacing as shown in FIG. 8 and then applied as an RNN (RNN layer) as in FIG. 9 to calculate high-pass filter values based on the previous and the current frame. Matrix-matrix multiplication may then be used to calculate differences between inputs and a high-pass filter value. The difference calculation may be done using a matrix copy, interleave, and DNN operation.

Merge feature vectors is an operation to provide feature vectors from the high pass filtered DCT results. A universal acoustic model uses feature vectors not only for the current frame, but also for previous frames as “background”. As a result feature vectors may be merged from multiple and different frames. Matrix-matrix multiplications are used with one dimension to copy data. All values are equal one. This is followed by several more matrix multiplications to complete the merging.

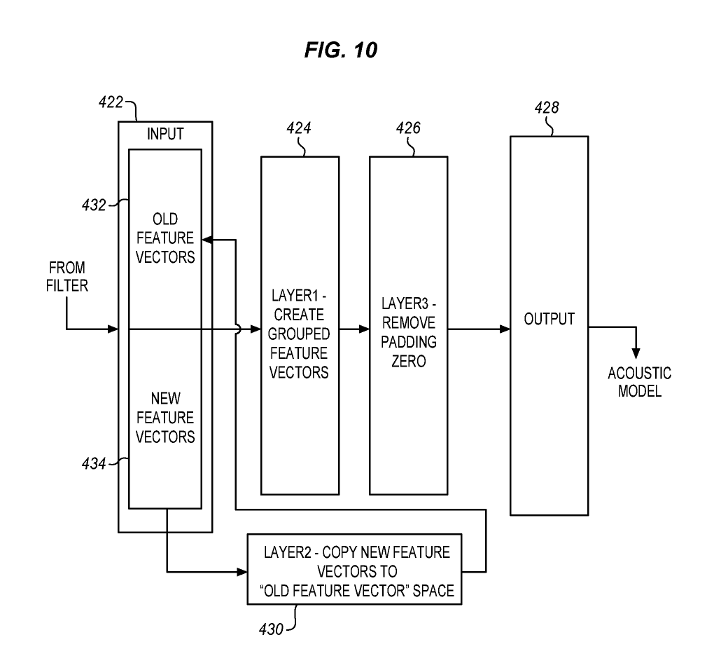

FIG. 10 is a hardware diagram of the merge features process as it may be implemented in the neural network. The input 422 contains new feature vectors 434 from the filter processes and old feature vectors 432 from a prior copy operation 430. As with the other processes, a copy operation may also be performed on a layer (layer 2 here) of the neural network accelerator. The inputs are provided to another layer (layer 1) to create grouped feature vectors using a de-interlace and a copy. This is provided to another layer (layer 3) to remove padding zeroes. This may be done, for example, using an interlace and a DNN. The result is produced as an output 428 to the acoustic models 330.

The acoustic models are used to match the feature vectors to particular speech or acoustic models. Matches are declared as recognized speech and are used to determine the utterance from the speaker. The speech may be in the form of words, phonemes, key phrases or some combination. The output may be text representing all of the statements in sentence form or logical constructs that represent the key meaning of a statement to the machine.

The examples above describe how operations of a speech recognition operation such as MFCC may be performed using layers and linear filters of neural network hardware. The hardware may be a specific neural network accelerator, or other neural network hardware. The modification is simply to configure the weights and biases of the layers, and the connections between the different layers. This may be done by the connected processor by setting parameters and setting registers for use as inputs and outputs. While a neural network operates by repeated layers and finding patterns, the described MFCC operates as a linear, deterministic technique even though the hardware is the same. After the speech processing, the connected processor may reconfigure the network to perform image recognition, machine vision, or some other task for which the hardware accelerator was designed.

Some or all of the operations described above from windowing to pre-processing, to filtering to Fourier and cosine transforms are also used in other types of audio feature extraction techniques. The approaches described are not limited to MFCC but may readily be adapted to other linear audio feature extraction techniques. Similarly the operation of the neural network layers and linear filters are also common for many different kinds of neural network hardware systems. Many such systems use layers, filtering, pooling, and feedback register connections to perform the networked tasks. These may be adapted in a similar way for MFCC or for other feature extraction techniques. Even within MFCC there are variations and modifications that have been developed for particular applications and these may be used here with suitable modifications to the described approach.

For some hardware configurations, there may be limits due to available registers and parameters, such as MMIO (Memory Mapped Input/Output) space. The modifications of the layers may be formed as “layer descriptors” that are stored in a configuration memory. After the audio is processed, a different set of layer descriptors may be used to return the hardware to operation for performing a neural network or artificial intelligence operation.

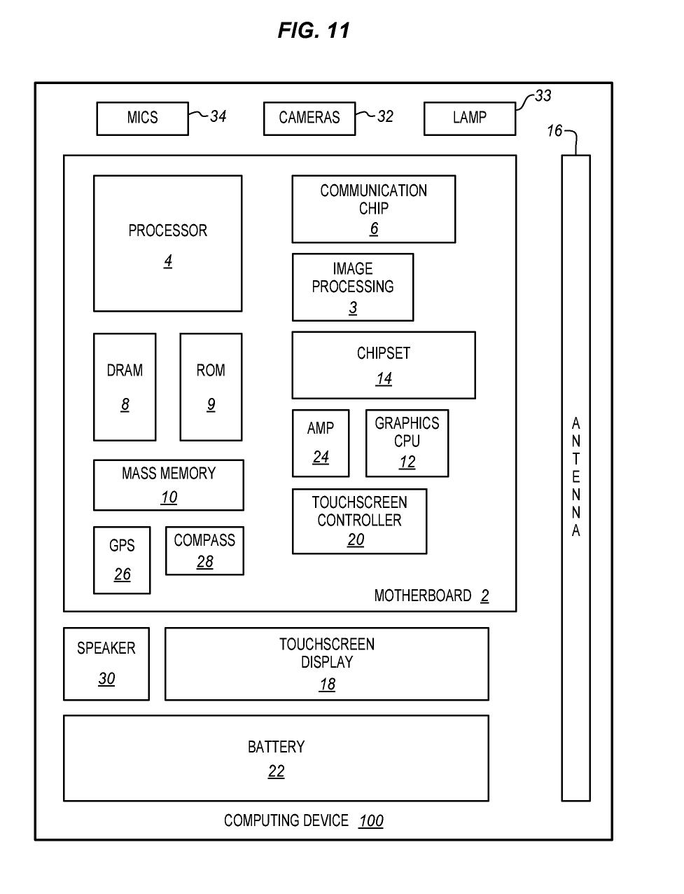

FIG. 11 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a lamp 33, a microphone array 34, and a mass storage device (such as a hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 contain image sensors with pixels or photodetectors as described herein. The image sensors may use the resources of an image processing chip 3 to read values and also to perform exposure control, depth map determination, format conversion, coding and decoding, noise reduction and 3D mapping, etc. The processor 4 is coupled to the image processing chip to drive the processes, set parameters, etc. In various embodiments, the system includes a neural network accelerator in the image processing chip 3, the main processor 4, the graphics CPU 12, or in other processing resources of the system. The neural network accelerator may be coupled to the microphones through an audio pipeline of the chipset or other connected hardware to supply audio samples to the neural network accelerator as described herein. The operation of the neural network accelerator may be controlled by the processor to change weights, biases, and registers to operate in the manner described herein for speech recognition.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, a digital video recorder, wearables or drones. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts.

The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method in which an audio clip is received for feature extraction. A plurality of feature extraction operations are performed on the audio clip using matrix-matrix multiplication of a hardware neural network accelerator, and features are produced for speech recognition.

In further embodiments the features comprise coefficients.

In further embodiments the coefficients are mel filter cepstrum coefficients.

Further embodiments include performing non-linear transformations for the feature extraction modeled as a piecewise linear function using the neural network for acoustic scoring.

Further embodiments include scaling intermediate values to reduce matrix values.

In further embodiments scaling comprises determining logarithms of sums using matrix-matrix multiplication.

In further embodiments the feature extraction operations comprise performing a Mel Filter Cepstrum Coefficients (MFCC) feature extraction.

In further embodiments windowing of the MFCC is performed using values of one or zero to split received streams into frames.

In further embodiments a discrete Fourier transform, power spectrum mapping, and discrete cosine transform of the MFCC are performed using multiplication hardware of the neural network.

In further embodiments the discrete cosine transform generates coefficients and wherein the coefficients are filtered and merged using matrix-matrix multiplications of the neural network hardware for application to an acoustic model for speech recognition.

Further embodiments include performing non-linear function transforms of the MFCC using piece wise linear functions of the hardware neural network accelerator.

In further embodiments performing feature extraction operations comprises pre-processing the audio clip by, windowing the audio clip, applying the windowed clip as an input to a neural network hardware layer to determine average values, applying the average values to another neural network hardware layer to perform subtraction on the average values.

In further embodiments producing features comprises a merge features operation performed by copying old features using a layer of the neural network accelerator, grouping features using another layer of the neural network accelerator and removing padding zeroes from the merged features using another layer of the neural network accelerator.

In further embodiments grouping features comprises first de-interlacing and then copying.

Some embodiments pertain to a feature extraction system that includes a hardware neural network accelerator, and a processor to receive an audio clip and to configure the hardware neural network accelerator to perform a plurality of feature extraction operations on the audio clip using matrix-matrix multiplication of the neural network accelerator to receive extracted features from the neural network accelerator and to recognize speech in the audio clip using the extracted features.

In further embodiments the processor configures the hardware neural network accelerator to perform a discrete Fourier transform, power spectrum mapping, and a discrete cosine transform of an MFCC using multiplication hardware of the neural network accelerator.

In further embodiments the discrete cosine transform generates coefficients and wherein the coefficients are filtered and merged using matrix-matrix multiplications of the neural network hardware for application to an acoustic model for speech recognition.

Some embodiments pertain to a portable device that includes an audio front end that includes an analog to digital converter to digitize received speech, and a feature extraction module to extract features from the digitized speech, an acoustic scoring model to receive the features and determine the significant features, and a backend search module to generate a representation of words included in the received speech, wherein the feature extraction module uses matrix-matrix multiplication of a neural network hardware accelerator to perform discrete Fourier transforms and discrete cosine transforms.

Further embodiments include a microphone coupled to the analog to digital converter to receive speech from a user.

Further embodiments include a communications chip to send the word representations to a remote device.

What is claimed is:

1. A method of feature extraction for a speech recognition comprising:
receiving an audio clip for feature extraction;
performing a plurality of feature extraction operations on the audio clip using matrix—matrix multiplication of a hardware neural network accelerator; and
producing features for speech recognition.

2. The method of claim 1, wherein the features comprise coefficients.

3. The method of claim 1, wherein the coefficients are mel filter cepstrum coefficients.

4. The method of claim 1, further comprising performing non-linear transformations for the feature extraction modeled as a piecewise linear function using the neural network for acoustic scoring.

5. The method of claim 1, further comprising scaling intermediate values to reduce matrix values.

6. The method of claim 5, wherein scaling comprises determining logarithms of sums using matrix-matrix multiplication.

7. The method of claim 1, wherein the feature extraction operations comprise performing a Mel Filter Cepstrum Coefficients (MFCC) feature extraction.

8. The method of claim 7, wherein windowing of the MFCC is performed using values of one or zero to split received streams into frames.

9. The method of claim 7, wherein a discrete Fourier transform, power spectrum mapping, and discrete cosine transform of the MFCC are performed using multiplication hardware of the neural network.

10. The method of claim 9, wherein the discrete cosine transform generates coefficients and wherein the coefficients are filtered and merged using matrix-matrix multiplications of the neural network hardware for application to an acoustic model for speech recognition.

11. The method of claim 7, further comprising performing non-linear function transforms of the MFCC using piece wise linear functions of the hardware neural network accelerator.

12. The method of claim 1, wherein performing feature extraction operations comprises pre-processing the audio clip by:
windowing the audio clip;
applying the windowed clip as an input to a neural network hardware layer to determine average values; and
applying the average values to another neural network hardware layer to perform subtraction on the average values.

13. The method of claim 1, wherein producing features comprises a merge features operation performed by copying old features using a layer of the neural network accelerator, grouping features using another layer of the neural network accelerator and removing padding zeroes from the merged features using another layer of the neural network accelerator.

14. The method of claim 1, wherein grouping features comprises first de-interlacing and then copying.

15. A feature extraction system comprising:
a hardware neural network accelerator; and
a processor to receive an audio clip and to configure the hardware neural network accelerator to perform a plurality of feature extraction operations on the audio clip using matrix—matrix multiplication of the neural network accelerator to receive extracted features from the neural network accelerator and to recognize speech in the audio clip using the extracted features.

16. The feature extraction system of claim 15, wherein the processor configures the hardware neural network accelerator to perform a discrete Fourier transform, power spectrum mapping, and a discrete cosine transform of an MFCC using multiplication hardware of the neural network accelerator.

17. The feature extraction system of claim 16, wherein the discrete cosine transform generates coefficients and wherein the coefficients are filtered and merged using matrix-matrix multiplications of the neural network hardware for application to an acoustic model for speech recognition.

18. A portable device comprising:
an audio front end that includes an analog to digital converter to digitize received speech, and a feature extraction module to extract features from the digitized speech;
an acoustic scoring model to receive the features and determine the significant features; and
a backend search module to generate a representation of words included in the received speech,
wherein the feature extraction module uses matrix-matrix multiplication of a neural network hardware accelerator to perform discrete Fourier transforms and discrete cosine transforms.

19. The device of claim 18, further comprising a microphone coupled to the analog to digital converter to receive speech from a user.

20. The device of claim 18, further comprising a communications chip to send the word representations to a remote device.
